SEQUENCE LISTING (28 sequences)

SEQ ID NO: 1 - DNA, 90 bp, Artificial Sequence
  Description of Artificial Sequence Synthetic polynucleotide
caagcagaagacggcatacgagatgtgactggagttcagacgtgtgctcttccgatctcctaaactacggactcctacgggaggcagcag

SEQ ID NO: 2 - DNA, 90 bp, Artificial Sequence
  Description of Artificial Sequence Synthetic polynucleotide
caagcagaagacggcatacgagatgtgactggagttcagacgtgtgctcttccgatctccatcacataggactcctacgggaggcagcag

SEQ ID NO: 3 - DNA, 91 bp, Artificial Sequence
  Description of Artificial Sequence Synthetic polynucleotide
caagcagaagacggcatacgagatgtgactggagttcagacgtgtgctcttccgatctactttaagggtgtactcctacgggaggcagcag

SEQ ID NO: 4 - DNA, 91 bp, Artificial Sequence
  Description of Artificial Sequence Synthetic polynucleotide
caagcagaagacggcatacgagatgtgactggagttcagacgtgtgctcttccgatctgagcaacatccttactcctacgggaggcagcag

SEQ ID NO: 5 - DNA, 92 bp, Artificial Sequence
  Description of Artificial Sequence Synthetic polynucleotide
caagcagaagacggcatacgagatgtgactggagttcagacgtgtgctcttccgatcttgttgcgtttctgtactcctacgggaggcagcag

SEQ ID NO: 6 - DNA, 92 bp, Artificial Sequence
  Description of Artificial Sequence Synthetic polynucleotide
caagcagaagacggcatacgagatgtgactggagttcagacgtgtgctcttccgatctaggtacgcaattgtactcctacgggaggcagcag

SEQ ID NO: 7 - DNA, 93 bp, Artificial Sequence
  Description of Artificial Sequence Synthetic polynucleotide
caagcagaagacggcatacgagatgtgactggagttcagacgtgtgctcttccgatcttgtctcgcaagccgaactcctacgggaggcagcag

SEQ ID NO: 8 - DNA, 94 bp, Artificial Sequence
  Description of Artificial Sequence Synthetic polynucleotide
caagcagaagacggcatacgagatgtgactggagttcagacgtgtgctcttccgatctgttacgtggttgatgaactcctacgggaggcagcag

SEQ ID NO: 9 - DNA, 94 bp, Artificial Sequence
  Description of Artificial Sequence Synthetic polynucleotide
caagcagaagacggcatacgagatgtgactggagttcagacgtgtgctcttccgatctcgtaagatgcctatgaactcctacgggaggcagcag

SEQ ID NO: 10 - DNA, 95 bp, Artificial Sequence
  Description of Artificial Sequence Synthetic polynucleotide
caagcagaagacggcatacgagatgtgactggagttcagacgtgtgctcttccgatcttaccggcttgcatgcgaactcctacgggaggcagcag

SEQ ID NO: 11 - DNA, 95 bp, Artificial Sequence
  Description of Artificial Sequence Synthetic polynucleotide
caagcagaagacggcatacgagatgtgactggagttcagacgtgtgctcttccgatctatctagtggcaatgcgaactcctacgggaggcagcag

SEQ ID NO: 12 - DNA, 96 bp, Artificial Sequence
  Description of Artificial Sequence Synthetic polynucleotide
caagcagaagacggcatacgagatgtgactggagttcagacgtgtgctcttccgatctcaccttaccttagagtggactcctacgggaggcagcag

SEQ ID NO: 13 - DNA, 96 bp, Artificial Sequence
  Description of Artificial Sequence Synthetic polynucleotide
caagcagaagacggcatacgagatgtgactggagttcagacgtgtgctcttccgatctgcacttcatttcgagtggactcctacgggaggcagcag

SEQ ID NO: 14 - DNA, 97 bp, Artificial Sequence
  Description of Artificial Sequence Synthetic polynucleotide
caagcagaagacggcatacgagatgtgactggagttcagacgtgtgctcttccgatctcgcggttactaacctggagactcctacgggaggcagcag

SEQ ID NO: 15 - DNA, 90 bp, Artificial Sequence
  Description of Artificial Sequence Synthetic polynucleotide
aatgatacggcgaccaccgagatctacactctttccctacacgacgctcttccgatctcctaaactacggggactachvgggtwtctaat

SEQ ID NO: 16 - DNA, 90 bp, Artificial Sequence
  Description of Artificial Sequence Synthetic polynucleotide
aatgatacggcgaccaccgagatctacactctttccctacacgacgctcttccgatctccatcacataggggactachvgggtwtctaat

SEQ ID NO: 17 - DNA, 91 bp, Artificial Sequence
  Description of Artificial Sequence Synthetic polynucleotide
aatgatacggcgaccaccgagatctacactctttccctacacgacgctcttccgatctactttaagggtgaggactachvgggtwtctaat

SEQ ID NO: 18 - DNA, 91 bp, Artificial Sequence
  Description of Artificial Sequence Synthetic polynucleotide
aatgatacggcgaccaccgagatctacactctttccctacacgacgctcttccgatctgagcaacatcctaggactachvgggtwtctaat

SEQ ID NO: 19 - DNA, 92 bp, Artificial Sequence
  Description of Artificial Sequence Synthetic polynucleotide
aatgatacggcgaccaccgagatctacactctttccctacacgacgctcttccgatcttgttgcgtttcttcggactachvgggtwtctaat

SEQ ID NO: 20 - DNA, 92 bp, Artificial Sequence
  Description of Artificial Sequence Synthetic polynucleotide
aatgatacggcgaccaccgagatctacactctttccctacacgacgctcttccgatctaggtacgcaatttcggactachvgggtwtctaat

SEQ ID NO: 21 - DNA, 93 bp, Artificial Sequence
  Description of Artificial Sequence Synthetic polynucleotide
aatgatacggcgaccaccgagatctacactctttccctacacgacgctcttccgatcttgtctcgcaagcctaggactachvgggtwtctaat

SEQ ID NO: 22 - DNA, 94 bp, Artificial Sequence
  Description of Artificial Sequence Synthetic polynucleotide
aatgatacggcgaccaccgagatctacactctttccctacacgacgctcttccgatctgttacgtggttggataggactachvgggtwtctaat

SEQ ID NO: 23 - DNA, 94 bp, Artificial Sequence
  Description of Artificial Sequence Synthetic polynucleotide
aatgatacggcgaccaccgagatctacactctttccctacacgacgctcttccgatctcgtaagatgcctgataggactachvgggtwtctaat

SEQ ID NO: 24 - DNA, 95 bp, Artificial Sequence
  Description of Artificial Sequence Synthetic polynucleotide
aatgatacggcgaccaccgagatctacactctttccctacacgacgctcttccgatctatctagtggcaaactcaggactachvgggtwtctaat

SEQ ID NO: 25 - DNA, 96 bp, Artificial Sequence
  Description of Artificial Sequence Synthetic polynucleotide
aatgatacggcgaccaccgagatctacactctttccctacacgacgctcttccgatctcaccttaccttattctctggactachvgggtwtctaat

SEQ ID NO: 26 - DNA, 96 bp, Artificial Sequence
  Description of Artificial Sequence Synthetic polynucleotide
aatgatacggcgaccaccgagatctacactctttccctacacgacgctcttccgatctgcacttcatttcttctctggactachvgggtwtctaat

SEQ ID NO: 27 - DNA, 97 bp, Artificial Sequence
  Description of Artificial Sequence Synthetic polynucleotide
aatgatacggcgaccaccgagatctacactctttccctacacgacgctcttccgatctcgcggttactaacacttctggactachvgggtwtctaat

SEQ ID NO: 28 - DNA, 97 bp, Artificial Sequence
  Description of Artificial Sequence Synthetic polynucleotide
aatgatacggcgaccaccgagatctacactctttccctacacgacgctcttccgatctgagactatatgccacttctggactachvgggtwtctaat

(19) United States
(12) Patent Application Publication
(10) Pub. No.: US 2022/0304335 A1
(43) Pub. Date: Sep. 29, 2022

(54) MODULATION OF ORAL MICROBIOTA

(71) Applicant: MARS, INCORPORATED, McLean, VA (US)

(72) Inventors: Lucy Jane HOLCOMBE, Melton Mowbray, Leicestershire (GB); Corryn Victoria WALLIS, Melton Mowbray, Leicestershire (GB); Avika Kishorlal RUPARELL, Melton Mowbray, Leicestershire (GB)

(73) Assignee: MARS, INCORPORATED, McLean, VA (US)

(21) Appl. No.: 17/616,916

(22) PCT Filed: Jun. 8, 2020
(86) PCT No.: PCT/US2020/036710

§ 371 Date: Dec. 6, 2021

(30) Foreign Application Priority Data
Jun. 6, 2019 (GB) 1908111.6

(51) Int. Cl. A23K 20/142; A23K 50/40

(52) U.S. Cl. CPC A23K 20/142; A23K 50/40

(57) ABSTRACT

Disclosed herein are edible products and related methods of modulating an oral microbiota of animals. The edible products include one or more sulfur containing amino acids, such as methionine, cysteine or a cysteine providing derivative, or combinations thereof. Such products and methods can advantageously reduce or prevent oral disease or disorder, e.g, periodontal disease, in animals such as dogs.

### CROSS-REFERENCE TO RELATED APPLICATION

This application claims priority to UK Patent Application No. 1908111.6, filed on Jun. 6, 2019, the contents of which are incorporated herein by reference in its entirety.

### FIELD

The presently disclosed subject matter relates to edible products and methods of modulating an oral microbiota of animals, particularly of dogs.

### SEQUENCE LISTING

The instant application contains a Sequence Listing which has been submitted electronically in ASCII format and is hereby incorporated by reference in its entirety. Said ASCII copy, created on Jun. 8, 2020, is named 0692690414.txt and is 7,900 bytes in size.

### BACKGROUND

Periodontal disease describes a spectrum of deteriorating conditions affecting the supporting tissues around the teeth. Clinical signs vary from redness and inflammation of the gingiva (gingivitis) to destruction of the tissues that support the teeth, in some cases leading to tooth loss (periodontitis). Presentation with the disease in small animal practice is frequent (Lund et al. 1999, O. Neill et al. 2014), and figures suggest that between 44% and 100% of the canine pet population are affected (Gad 1968, Harvey et al. 1994, Hoffmann and Gaengler 1996, Kyllar and Witter 2005, Kortegaard et al. 2008).

The development of periodontal disease follows a multifactorial hypothesis, where microbial contributors play a fundamental role via dental plaque. As such, scientific investigations have elucidated several theories regarding the role of bacteria in the initiation of pathogenesis. Regardless of the precise mechanism, however, it is through disturbances to the equilibrium of the oral ecosystem and associated bacterial community that initiates the disease cascade. Understanding fluctuations in microbiota is now possible due to advancements in molecular sequencing and bioinformatics technologies which allow a holistic perspective of canine oral plaque bacteria (Riggio et al. 2011, Davis et al. 2013, Wallis et al. 2015). These advancements have not only delivered the ability to perform comparative analyses across different time points, for example, in the disease's progression, but additionally have aided the understanding of bacterial associations between health states. Significant insights in this area to date have been provided by comprehensive in vivo studies. A cross-sectional survey of plaque bacterial species from 223 client owned dogs with healthy gingiva, gingivitis or mild periodontitis found health was associated with Gram negative genera including Bergeyella, Moraxella and Porphyromonas while mild periodontitis was associated with the Gram positive genera Actinomyces, Peptostreptococcus and Peptostreptococcaceae (Davis et al. 2013). In a longitudinal study focusing on miniature schnauzers, Wallis et al. 2015 collected subgingival plaque samples every six weeks for a period up to 60 weeks. With the progression to mild periodontitis, they observed a reduction in the abundance of particular Gram negative species, namely Bergeyella zoohelcum COT-186, Moraxella sp. COT-017, Pasteurellaceae sp. COT-080, and Neisseria shayeganii COT-090.

Prevention of periodontal disease is undoubtedly preferred than the necessity for treatment. Strategies including tooth brushing and the use of regular oral care chews and/or dental diets aim to maintain a healthy homeostasis through restricting plaque (and dental calculus) growth to low levels (Gorrel and Bierer 1999, Gorrel et al. 1999, Brown and McGenity 2005, Hennet et al. 2006, Clarke et al. 2011, Quest 2013, Harvey et al. 2015).

The maintenance of oral health in animals is important to maintain the overall health of the animal. Pet food products exist that offer some benefit to the oral health of animals; however, such foods generally work via mechanical action, that is to say they effect changes in oral health by helping to keep an animal's teeth clean, through removal of plaque from the teeth by abrasion. Although such products can aid in the maintaining of the oral health of animals, there still exists a need to provide improved means for maintaining the oral health of animals and, in particular, for modulating the oral microbiota.

The influence of diet constituents on oral microbiota, for example in canines, is poorly understood. Accordingly, there exists a need for improved edible products and methods of modulating oral microbiota in animals, particularly to reduce or prevent oral disease or disorder (e.g., periodontal disease). The presently disclosed subject matter has advantageously identified that feeding a particular diet to animals can have a significant effect on their oral microbiota in order to promote a healthier microbiota and reduce the likelihood of the development of oral disease or disorder (e.g., periodontal disease). The presently disclosed subject matter further provides a means for maintaining the oral health of animals in the form of an edible product that modulates the oral microbiota of an animal when it is consumed.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages, and in accordance with the purpose of the disclosed subject matter, as embodied and broadly described, the disclosed subject matter includes in one aspect an edible product for modulating the oral microbiota in a companion animal, wherein the edible product comprises a sulfur containing amino acid.

In certain aspects, the edible product is an edible product comprising, or for delivering to the animal, an increased amount of at least one sulfur containing amino acid, when compared to the animal's usual diet, for example, a standard animal feed. The edible product can be a complete animal feed, i.e., a feed that provides all the usual dietary requirements, but that comprises an increased amount of at least one sulfur containing amino acid. Alternatively, the edible product can be a supplement or additive to the animal's usual diet. The edible product can be nutritionally complete. The edible product can be a chew. In certain embodiments, the edible product is not a chew.

Sulfur containing amino acids include methionine, cysteine and taurine. The sulfur containing amino acid can be methionine or a methionine related amino acid or derivative. Alternatively, it can be cysteine or a cysteine providing derivative. In a particular embodiment, the edible product comprises methionine and cysteine or a cysteine providing derivative.

In certain aspects, the edible product is for delivering to the animal at least about 0.5 g/1,000 kcal methionine, at least about 0.55 g/1,000 kcal methionine, at least about 0.60 g/1,000 kcal methionine, at least about 0.65 g/1,000 kcal methionine, at least about 0.70 g/1,000 kcal methionine, at least about 0.75 g/1,000 kcal methionine, at least about 0.80 g/1,000 kcal methionine, at least about 0.85 g/1,000 kcal methionine, or at least about 0.90 g/1,000 kcal methionine. In one aspect, the edible product is for delivering at least about 1.3 g/1,000 kcal methionine, at least about 1.35 g/1,000 kcal methionine, or at least about 1.37 g/1,000 kcal methionine to the animal. In certain embodiments, the edible product is for delivering to the animal at least about 0.71 g/1,000 kcal methionine.

In certain aspects, the edible product is for to the animal at least about 1.25 g/1,000 kcal cysteine, at least about 1.4 g/1,000 kcal cysteine, at least about 1.5 g/1,000 kcal cysteine, at least about 1.65 g/1000 kcal cysteine, at least about 1.75 g/1000 kcal cysteine, at least about 1.9 g/1,000 kcal cysteine, at least about 1.95 g/1,000 kcal cysteine, at least about 2.0 g/1000 kcal cysteine, or at least about 2.10/1,000 kcal cysteine. In one aspect, the edible product is for delivering at least about 1.25 g/1,000 kcal cysteine, at least about 1.30 g/1,000 kcal cysteine, or at least about 1.31 g/1,000 kcal cysteine to the animal. In certain embodiments, the edible product is for delivering to the animal less than about 1.97 g/1,000 kcal cysteine.

In certain embodiments, the edible product is for delivering both methionine, or a methionine-related amino acid or derivative and cysteine, or a cysteine providing derivative. The cysteine or cysteine providing derivative can be present in an amount such that the weight ratio of methionine to available cysteine is from about 1:0.8 to about 1:2.5. In certain embodiments, the edible product is for delivering to the animal both methionine or methionine-related amino acid and cysteine or a cysteine providing derivative such that the available weight ratio of methionine to cysteine is about 1:0.95 to less than or about 1:2.77.

The oral microbiota can be modulated by increasing or decreasing the presence or prevalence of particular microorganisms, particularly bacterial species or groups of bacterial species. For example, the oral microbiota can be modulated by increasing the number of bacterial species associated with good oral health, particularly species strongly associated with good oral health in a companion animal to which the edible product is administered, compared to the expected microbiota in that companion animal, if the edible product was not administered. The oral microbiota can also be modulated by increasing the prevalence, i.e., the number present, of one or more bacterial species associated with good oral health, particularly one or more bacterial species strongly associated with good oral health. The oral microbiota can also be modulated by increasing the ratio of bacteria or bacterial species associated with good oral health to bacteria or bacterial species associated with poor oral health or disease in the oral microbiota.

Bacterial species associated or strongly associated with good oral health are known in the art. Bacterial species associated or strongly associated with good oral health can include bacteria from the phyla Bacteroidetes and Proteobacteria. Modulating the oral microbiota can comprise increasing the prevalence of Lautropia sp. COT-060.

The oral microbiota can be modulated by decreasing the number of bacterial species associated with poor oral health or with disease, particularly species strongly associated with poor oral health or disease in an animal to which the edible product is administered, compared to the expected microbiota in that animal, if the edible product was not administered. The oral microbiota can also be modulated by decreasing the prevalence or relative proportion, i.e., the number present, of one or more bacterial species associated with poor oral health or disease, particularly one or more bacterial species strongly associated with poor oral health or disease.

Bacterial species associated or strongly associated with poor oral health or disease are known in the art. Bacterial species associated or strongly associated with poor oral health or disease can include bacteria from the phyla Firmicutes. Modulating the oral microbiota can comprise decreasing the prevalence of Peptostreptococcaceae bacterium COT-021 and/or Peptostreptococcaceae bacterium COT-030.

In certain aspects, the edible product can also be effective in longer term modulation of the oral microbiota, thus causing modulation of the microbiota for a period of time following administration of the edible product, even if the animal has returned to a standard diet.

In certain aspects, the edible product can be for administration daily or more than once daily.

In certain aspects, the edible product can be for administration for at least 5, 10, 15, 20, 25, 30, 45, 60, 90 or 120 times.

In one embodiment, the edible product is for administration to an animal with a clean mouth, e.g., after it has received a scale and polish. Without being bound by the theory, the edible product is thought to encourage the colonization of the clean mouth with more bacteria not associated with periodontal disease compared to a clean mouth to which an edible product is not administered.

In one embodiment, the animal is a dog. The dog can be any breed of dog, including toy, small, medium, large and giant breeds. In one embodiment, the dog is a medium, large or giant breed.

In certain aspects, modulating the oral microbiota can result in improved oral health, for example, by lowering the likelihood of the animal developing periodontal disease.

In another aspect, the present disclosure provides an edible product for improving the oral health of a companion animal, wherein the oral health is improved by modulation of the oral microbiota.

In another aspect, the present disclosure provides the use of an edible product for improving oral health, wherein the oral health is improved by modulation of the oral microbiota.

In another aspect, the present disclosure provides a method of modulating the oral microbiota in a companion animal, comprising the step of feeding the animal a diet comprising an increased amount of one or more sulfur containing amino acids. The diet can comprise an edible product according certain aspects of the present disclosure.

In certain embodiments, the step of feeding the animal the diet can be carried out, for example 5, 10, 15, 20, 25, 30, 45, 60, 90 or 120 times. In certain aspects, the edible product can be fed to the animal daily or more than once daily.

In certain embodiments, the animal can be an animal with a clean mouth, for example, an animal that has received a scale and polish, or that has had its teeth cleaned, or generally having healthy gingiva.

In certain aspects, the method can also comprise the step of cleaning the animal's teeth or mouth.

In another aspect, the present disclosure provides for a method for improving the oral health of an animal by modulating the animal's oral microbiota, comprising the step of feeding the animal a diet comprising an increased amount of one or more sulfur containing amino acids. The diet can comprise an edible product according to certain aspects of the present disclosure.

In certain embodiments, the step of feeding the animal the diet can be carried out, for example 5, 10, 15, 20, 25, 30, 45, 60, 90 or 120 times. In certain aspects, the edible product can be fed to the animal daily, twice weekly, weekly or fortnightly.

Features of the aspects of the present disclosure can be as defined in relation to the first listed aspect of the present disclosure. In particular, the term increased amount of one or more sulfur containing amino acids in aspects of the present disclosure can be as defined in relation to the increased amount of one or more sulfur containing amino acids in the first listed aspect of the present disclosure.

In certain aspects, the present disclosure provides an edible product comprising one or more sulfur containing amino acids. The one or more sulfur containing amino acids include at least about 0.5 g/1,000 kcal methionine or methionine-related amino acid and at least about at least about 1.25 g/1,000 kcal cysteine or cysteine related amino acid.

In certain embodiments, the product is an animal feed. In alternative embodiments, the product is a feed supplement or additive.

In certain embodiments, the product can include methionine or a methionine-related amino acid and cysteine or a cysteine providing derivative such that the available weight ratio of methionine to cysteine is about 1:0.8 to about 1:2.5.

In certain aspects, the product is not a chew. In certain embodiments, the product is nutritionally complete. In alternative embodiments, the product is a supplement.

In another aspect, the present disclosure provides a method of modulating an oral microbiota of a companion animal. The method includes administering an edible pet food product comprising one or more sulfur containing amino acids to the animal. The one or more sulfur containing amino acids include at least about 0.5 g/1,000 kcal methionine or methionine-related amino acid and at least about at least about 1.25 g/1,000 kcal cysteine or cysteine related amino acid.

In certain embodiments, the edible pet food product is administered daily or more than once daily. In certain embodiments, the edible pet food product is administered at least 5 times. In particular aspects, the edible pet food product is administered at least 5, 10, 15, 20, 25, 30, 45, 60, 90 or 120 times.

In certain aspects, modulating the oral microbiota includes increasing the number of species of or prevalence of bacteria associated with good oral health. Further, in certain aspects, modulating the oral microbiota comprises decreasing the number of species of or prevalence of bacteria associated with poor oral health or disease.

In particular aspects, modulating the oral microbiota includes increasing the number of species of or prevalence of bacteria from the phyla Bacteroidetes and/or Proteobacteria; increasing the prevalence of bacteria from the species Lautropia sp. COT-060; decreasing the number of species of or prevalence of bacteria from the phyla Firmicutes; or decreasing the prevalence of bacteria from the species Peptostreptococcaceae bacterium COT-021 and/or Peptostreptococcaceae bacterium COT-030.

In certain embodiments, the edible pet food product is administered in an amount effective to improve the oral health of an animal.

In certain embodiments, the companion animal is a dog.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the kits and methods of the disclosed subject matter. Together with the description, the drawings serve to explain the principles of the disclosed subject matter.

### BRIEF DESCRIPTION OF THE DRAWINGS

The present disclosure will now be described in detail, by way of example only, with reference to the drawings, in which:

FIG. 1A: Phylogenetic distribution of operational taxonomic units (OTUs) based on sequence read counts for one of three semi-purified diet groups, Diet Group A (Diet A, DG-A), in accordance with Example 1.

FIG. 1B: Phylogenetic distribution of operational taxonomic units (OTUs) based on sequence read counts for one of three semi-purified diet groups, Diet Group B (Diet B, DG-B), in accordance with Example 1.

FIG. 1C: Phylogenetic distribution of operational taxonomic units (OTUs) based on sequence read counts for one of three semi-purified diet groups, Diet Group C (Diet C, DG-C) in accordance with Example 1.

FIG. 2: Shannon diversity index for samples from the three semi-purified diet groups (Diet Group A, Diet Group B, and Diet Group C) in accordance with Example 1.

### DETAILED DESCRIPTION

Reference will now be made in detail to the various exemplary embodiments of the disclosed subject matter, exemplary embodiments of which are illustrated in the accompanying drawings. The presently disclosed subject matter relates to edible products and related methods of modulating an oral microbiota of animals. The presently disclosed subject matter is particularly suited for modulating the microbiota of a companion animal, e.g., a domestic dog.

### A. Definitions

The terms used in this specification generally have their ordinary meanings in the art, within the context of the present disclosure and in the specific context where each term is used. Certain terms are discussed below, or elsewhere in the specification, to provide additional guidance to the practitioner in describing the methods and compositions of the present disclosure and how to make and use them.

Throughout the description and claims of this specification, the words “comprise” and “contain” and variations of the words, for example “comprising” and “comprises,” mean “including but not limited to,” and do not exclude other components, integers or steps. Moreover, the singular encompasses the plural unless the context otherwise requires. In particular, where the indefinite article is used, the specification is to be understood as contemplating plurality as well as singularity, unless the context requires otherwise.

As used herein, the use of the word “a” or “an” when used in conjunction with the term “comprising” in the claims and/or the specification can mean “one,” but it is also consistent with the meaning of “one or more,” “at least one,” and “one or more than one.” Still further, the terms “having,” “including,” “containing” and “comprising” are interchangeable and one of skill in the art is cognizant that these terms are open ended terms.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, up to 10%, up to 5%, or up to 1% of a given value. Alternatively, particularly with respect to biological systems or processes, the term can mean within an order of magnitude, within 5-fold, or within 2-fold, of a value.

The term “animal” as used in accordance with the present disclosure refers to a wide variety of animals, such as quadrupeds, primates, and other mammals. For example, the term “animal” can refer to domestic animals including, but not limited to, dogs, cats, horses, cows, ferrets, rabbits, pigs, rats, mice, gerbils, hamsters, goats, and the like. The term “animal” can also refer to wild animals including, but not limited to, bison, elk, deer, venison, duck, fowl, fish, and the like. In some embodiments, the animal is a companion animal. In certain instances, the animal is a domestic dog or cat.

The terms “animal feed,” “animal feed compositions,” “pet food,” “pet food article,” “pet food product”, “edible product” or “pet food composition” are used interchangeably herein and refer to a composition intended for ingestion by an animal or pet. Any composition intended for ingestion by an animal or pet is suitable for use with the present disclosure. Such compositions can include kibble or dry foods, moist or wet foods, semi-moist foods, frozen or freeze-dried foods, raw foods, or combinations thereof. Compositions of the present disclosure can be used, for example, as a main meal, a meal supplement, a treat, or a combination thereof. The compositions can be nutritionally balanced. In alternate embodiments, the compositions are not nutritionally balanced. For example, and not by way of limitation, pet foods can include, without limitation, nutritionally balanced compositions suitable for daily feed, such as kibbles, as well as supplements and/or treats, which can be nutritionally balanced. In an alternative embodiment, the supplement and/or treats are not nutritionally balanced. In certain aspects, the supplement can include a topper.

The terms “chew” or “oral chew” refers an edible product that in some instances, in one aspect, can be differentiated from food by virtue of its nutritional content. Specifically, a conventional dog “food” is nutritionally complete and provides the full range of the dog's daily nutrition requirements. It is also intended to be the major source of the dog's calorific intake. A chew need not provide such nutrition or calorific content. A chew can further be distinguished from a “food” with regard to its size. The largest pieces in a food product are generally smaller than the size of a chew. A chew can be further distinguished with regard to the time taken to consume a piece of chew compared to a piece of food. Normally the consumption time for a piece of chew is much longer than a piece of food. A piece of food can generally be consumed in less than 10 seconds by an average sized dog, whereas a chew would take at least 20 seconds for an average-sized dog to consume. In one embodiment, a chew of the present disclosure would typically take at least 90 seconds, more typically at least 120 seconds for an average-sized dog to consume. For example, and not by way of limitation, the edible chew product can be moulded, aerated or extruded.

The phrase “expected microbiota” can refer to the actual microbiota found before the administration of the edible product. In one embodiment, the expected microbiota can refer to the actual microbiota found before the administration of the edible product and before any method has been used to clean the animal's mouth such as a scale and polish. Alternatively, it can refer to the predicted microbiota, based on microbiota found in other animals of the same or similar species or breeds.

The phrase “modulating the oral microbiota” refers to causing the oral microbiota population to change, compared to the oral microbiota that would be expected to be found if the animal had not been fed the edible product of the present disclosure. Modulation of the oral microbiota can comprise promoting health-associated oral cavity flora.

The terms “nutritionally balanced” or “nutritionally complete” in reference to a composition means that the composition, such as pet food, has known required nutrients to sustain life in proper amounts and proportion based on recommendations of recognized authorities, including governmental agencies, such as, but not limited to, National Research Council (NRC) and The European Pet Food Industry (FEDIAF) guidelines (e.g., http://www.fediaf.org/images/FEDIAF_Nutritional_Guidelines_2019_Update_030519.pdf), in the field of pet nutrition, except for the additional need for water.

As used herein, the term “oral disease or disorder,” refers to a disease or disorder that occurs in an oral cavity of a subject (e.g., an animal) and that is caused by or is associated with one or more bacteria. For example, the disease or disorder can affect the teeth or the gums of the subject. Exemplary oral diseases or disorders of the present disclosure include, but are not limited to, periodontal disease, caries, gingival stomatitis, odontoclastic resorptive lesions, and oral malodor.

The term “oral microbiota” refers to the microorganisms found in the oral cavity. In particular, it can refer to the bacteria found in the oral cavity, and more specifically to bacterial composition of dental plaque or oral biofilms. It can refer to plaque above (supragingival) and/or below the gum line (subgingival), and/or gingival margin plaque, or biofilms present in the mouth such as on the tongue or cheek or bacteria in the saliva.

As used herein, the term “periodontal disease,” also known as gum disease, refers to an inflammation or infection that affect the tissues surrounding the teeth. Periodontal disease can range in severity, e.g., from gingivitis (e.g., dental plaque-induced gingivitis) to periodontitis.

As used herein, and as is well-understood in the art, “treatment” refers to an approach for obtaining beneficial or desired results, including clinical results. For purposes of this subject matter, beneficial or desired clinical results include, but are not limited to, alleviation or amelioration of one or more symptoms, diminishment of extent of a disorder, stabilized (i.e., not worsening) state of a disorder, prevention of a disorder, delay or slowing of the progression of a disorder, and/or amelioration or palliation of a state of a disorder. The decrease can be an about 0.01%, about 0.1%, about 1%, about 5%, about 10%, about 20%, about 30%, about 40%, about 50%, about 60%, about 70%, about 80%, about 90%, about 95%, about 98% or about 99% decrease in severity of complications or symptoms. “Treatment” can also mean prolonging survival as compared to expected survival if not receiving treatment. The term “preventing,” as used herein, means partially or completing treating before the disorder or condition occurs.

As used herein, the term “weight percent” is meant to refer to the quantity by weight of a constituent or component, for example, in the pet food composition as a percentage of the overall weight of the pet food composition. The terms “weight percent,” “wt-%,” “wt. %”, and “wt %” are used interchangeably.

Preferred features of each aspect of the presently disclosed subject matter can be as described in connection with any of the other aspects. Within the scope of this application, it is expressly intended that the various aspects, embodiments, examples and alternatives set out in the preceding paragraphs, in the claims and/or in the following description and drawings, and in particular the individual features thereof, can be taken independently or in any combination. That is, all embodiments and/or features of any embodiment can be combined in any way and/or combination, unless such features are incompatible.

### B. Bacteria in the Oral Microbiota/Microbiome

The present disclosure relates to, inter alia, edible products and related methods for modulating the oral microbiota of an animal. The one or more bacteria modulated can be associated with an oral disease or disorder, e.g., periodontal disease, or good oral health. The animal can be a companion animal, such as a domestic dog or a cat. In particular aspects, the companion animal is a domestic dog. The dog can be any breed of dog, including toy, small, medium, large and giant breeds. In certain embodiments, the dog is a medium, large or giant breed.

In some embodiments, the one or more bacteria associated with periodontal disease can be Peptostreptococcaceae sp. In some embodiments, the one or more bacteria associated with periodontal disease is selected from the group consisting of Peptostreptococcus sp., Synergistes sp., Clostridiales sp., Eubacterium nodatum, Selenomonas sp., Bacteroidetes sp., Odoribacter denticanis, Desulfomicrobium ovale, Moraxella sp., Bacteroides denticanoris, Filifactor villosus, Porphyromonas canoris, Porphyromonas gulae, Treponema denticola, or Porphyromonas salivosa. In certain embodiments, the one or more bacteria includes Peptostreptococcus sp., volatile organic compound producing bacteria, or both. In further embodiments, the one or more bacteria includes Peptostreptococcaceae XIII [G-1] sp., Peptostreptococcaceae COT-030, Peptostreptococcaceae COT-005/004, Peptostreptococcaceae COT-047, and/or Peptostreptococcaceae COT-019.

Bacterial community profiles within an oral microbiome of an animal can vary depending on the source of a sample taken from the animal. For example, three discrete oral niches can include soft tissue surfaces, such as the lip, cheek, and tongue; hard tissue surfaces, such as the teeth; and saliva. In some embodiments, the oral niche is from a hard tissue surface, such as one or more teeth. In some embodiments, the oral niche includes the gingival margin or supragingival surface.

In certain embodiments, the oral microbiota can be modulated by increasing or decreasing the presence or prevalence of particular microorganisms, particularly bacterial species or groups of bacterial species. For example, and not by way of limitation, bacterial species or groups of bacterial species can include Firmicutes, Bacteroidetes, Proteobacteria, Actinobacteria, Saccharibacteria, Unclassified (Rares), Synergistetes, Absconditabacteria, Fusobacteria, WS6, Gracilibacteria, Spirochaetae, Chlorobi, or combinations thereof.

The oral microbiota can be modulated by increasing the number of bacterial species associated with good oral health, particularly species strongly associated with good oral health in a companion animal to which the edible product is administered, compared to the expected microbiota in that companion animal, if the edible product was not administered. In certain embodiments, the oral microbiota can also be modulated by increasing the prevalence, i.e., the number present, of one or more bacterial species associated with good oral health, particularly one or more bacterial species strongly associated with good oral health. In certain embodiments, the oral microbiota can also be modulated by increasing the ratio of bacteria or bacterial species associated with good oral health to bacteria or bacterial species associated with poor oral health or disease in the oral microbiota.

Bacterial species associated or strongly associated with good oral health can include bacteria from the phyla Bacteroidetes and Proteobacteria. Modulating the oral microbiota can comprise increasing the prevalence of Lautropia sp. COT-060.

In certain aspects, the oral microbiota can be modulated by decreasing the number of bacterial species associated with poor oral health or with disease, particularly species strongly associated with poor oral health or disease in an animal to which the edible product is administered, compared to the expected microbiota in that animal, if the edible product was not administered. In certain embodiments, the oral microbiota can also be modulated by decreasing the prevalence or relative proportion, i.e., the number present, of one or more bacterial species associated with poor oral health or disease, particularly one or more bacterial species strongly associated with poor oral health or disease.

Bacterial species associated or strongly associated with poor oral health or disease can include bacteria from the phyla Firmicutes. Modulating the oral microbiota can comprise decreasing the prevalence of Peptostreptococcaceae bacterium COT-021 and/or Peptostreptococcaceae bacterium COT-030.

### C. Sulfur Containing Amino Acids

Sulfur containing amino acids are amino acids that contribute to the maintenance and integrity of several cellular systems, e.g., cellular redox state, detoxification from free radicals and reactive oxygen species. Sulfur belongs to the same group in the periodic table as oxygen but is much less electronegative. This difference accounts for some distinctive properties of the sulfur containing amino acids. Sulfur containing amino acids are cytotoxic to prokaryotes.

In certain embodiments, the sulfur containing amino acid can be L-amino acid or D-amino acid. In certain embodiments, the sulfur containing amino acid is methionine or a methionine-related amino acid. In certain embodiments, the sulfur containing amino acid is cysteine. In certain embodiments, the sulfur containing amino acid is a cysteine providing derivative. In certain embodiments, the sulfur containing amino acid is homocysteine. In certain embodiments, the sulfur-containing amino acid is taurine. In certain embodiments, the sulfur containing amino acid is N-acetyl cysteine.

In certain embodiments, without limitation, the sulfur containing amino acid can be cysteine sulfinic acid, cysteic acid, homocysteine sulfinic acid, homocysteic acid, serine-O-sulfate, and S-sulfo-cysteine. In certain embodiments, the sulfur-containing amino acid can be a sulfur-containing amino acid derivative. In certain embodiments, the sulfur containing amino acid derivative can be a protogenic or non-protogenic amino acid containing a thiol-group, a mercaptan-group, or a thioester-group. Non-limiting examples for sulfur-containing amino acid derivative include S-adenosylmethionine, cystathionine, S-adenosylhomocysteine, glutathione, N-Carbamoyl-L-cysteine, N-Acetylcysteamine, γ-thiomethyl glutamate, 2-amino-Δ2-thiazoline-4-carboxylic acid, 3-methylthioaspartic acid, 3-thio-L-aspartic acid, S-substituted L-cysteine, D-penicillamine disulfide, L-homolanthionine, L-polyhomomethionine, cystine, dihomomethionine, ergothioneine, hexahomomethionine, hexahomomethionine S-oxide, homocystines, homomethionine, pentahomomethionine, pentahomomethionine S-oxide, tetrahomomethionine, thioproline, and trihomomethionine. Additional non-limiting examples of sulfur containing amino acids include alliin, S-allyl cysteine, S-aminoethyl-L-cysteine, cysteinyldopa, Djenkolic acid, ethionine, felinine, N-formylmethionine, hawkinsin, lanthionine, and lanthionine ketimine.

In certain embodiments, the presently disclosed subject matter contemplates prodrugs of sulfur containing amino acids. For example, but not way of limitation, prodrugs of sulfur containing amino acids can be 2-(polyhydroxy-alkyl)thiazolidine-4(R)-carboxylic acid and 2-(polyacetoxyalkyl)thizolidine-4(R)-carboxylic acid.

In certain embodiments, the sulfur containing amino acid of the presently disclosed subject matter is delivered to the animal in an amount from about 0.001 g to about 10 g per 1,000 kcal. For example, but not by way of limitation, the sulfur containing amino acid can be present in the amount of about 1 mg to about 10 g, from about 10 mg to about 10 g, from about 100 mg to about 10 g, from about 250 mg to about 10 g, from about 500 mg to about 10 g, from about 750 mg to about 10 g, from about 1 g to about 10 g, and values in between.

### D. Edible Product

The present disclosure provides edible products and related methods of modulating the oral microbiota of animals. Modulating the oral microbiota can result in improved oral health, for example by lowering the likelihood of the animal developing periodontal disease. In particular embodiments, the oral microbiota of animals is modulated by administering an edible product including one or more sulfur containing amino acids to the animal. In particular embodiments, the one or more sulfur containing amino acids can include methionine, cysteine or a cysteine providing derivative, or combinations thereof. In certain embodiments, the one or more sulfur containing amino acids can include taurine. In certain embodiments, the one or more sulfur containing amino acids can include N-acetyl cysteine.

The edible product can also be effective in longer term modulation of the oral microbiota and cause modulation of the microbiota for a period of time following administration of the edible product, even if the animal has returned to a standard diet.

Edible products of the present disclosure can be a complete animal feed, i.e., a feed that provides all the usual dietary requirements, but that includes an increased amount of at least one sulfur containing amino acid when compared to the animal's usual diet, for example, a standard animal feed. Alternatively, the edible product can be a supplement to the animal's usual diet. In certain embodiments, the edible product can be nutritionally complete. In particular embodiments, the edible product is a chew product. For example, and not by way of limitation, the edible chew product can be moulded, aerated or extruded. In an alternative embodiment, the edible product is not a chew product. Any composition intended for ingestion by an animal or pet is suitable for use with the present disclosure. Such compositions can include kibble or dry foods, moist or wet foods, semi-moist foods, frozen or freeze-dried foods, raw foods, or combinations thereof. Compositions of the present disclosure can be used, for example, as a main meal, a meal supplement, a treat, or a combination thereof. The compositions can be nutritionally balanced. In alternate embodiments, the compositions are not nutritionally balanced. For example, and not by way of limitation, pet foods can include, without limitation, nutritionally balanced compositions suitable for daily feed, such as kibbles, as well as supplements and/or treats, which can be nutritionally balanced. In an alternative embodiment, the supplement and/or treats are not nutritionally balanced.

In certain embodiments, the edible product can include an increased amount of at least one sulfur containing amino acid when compared to the animal's usual diet. For example, and not by way of limitation, in certain embodiments, the edible product can include an increased amount of methionine or methionine-related amino acid when compared to the animal's usual diet. In certain embodiments, the edible product can include a decreased amount of at least one sulfur containing amino acid when compared to the anima's usual diet. For example, and not by way of limitation, in certain embodiments, the edible product can include a decreased amount of cysteine or cysteine-related amino acid when compared to the animal's usual diet. In particular embodiments, the edible product can include an increased amount of methionine or methionine-related amino acid and a decreased amount of cysteine or cysteine-related amino acid when compared to the animal's usual diet.

In certain embodiments, the edible product can include one or more sulfur containing amino acids. Amounts of the one or more sulfur containing amino acids vary depending on the food product administered. The one or more sulfur containing amino acids can be present in an amount of at least about 0.5 g/1,000 kcal, about 0.55 g/1,000 kcal, about 0.60 g/1,000 kcal, about 0.65 g/1,000 kcal, about 0.70 g/1,000 kcal, about 0.71 g/1,000 kcal, about 0.75 g/1,000 kcal, about 0.80 g/1000 kcal, about 0.85 g/1,000 kcal, about 0.90 g/1,000 kcal, about 1.25 g/1,000 kcal, about 1.3 g/1,000 kcal, about 1.31 g/1,000 kcal, about 1.35 g/1,000 kcal, about 1.37 g/1,000 kcal, about 1.4 g/1,000 kcal, about 1.5 g/1,000 kcal, about 1.65 g/1000 kcal, about 1.75 g/1000 kcal, about 1.9 g/1,000 kcal, about 1.95 g/1,000 kcal, about 1.97 g/1,000 kcal, about 2.0 g/1000 kcal, about 2.10 g/1,000 kcal, about 2.13 g/1,000 kcal, about 2.5 g/1,000 kcal, about 2.6 g/1,000 kcal, about 2.68 g/1,000 kcal, about 2.7 g/1,000 kcal. In particular embodiments, the one or more sulfur containing amino acids can be present in the edible product in an amount of from about 0.5 g/1,000 kcal to about 3 g/1,000 kcal, about 1 g/1,000 kcal to about 2.8 g/1,000 kcal, or about 2.68 g/1,000 kcal. In particular embodiments, the edible product can include one or more amino acids present in an amount of about 1 g/1,000 kcal, about 1.5 g/1,000 kcal, about 2.68 g/1,000 kcal, about 2.7 g/1,000 kcal, or about 3 g/1,000 kcal. A person skilled in the art would appreciate that varying amounts of one or more sulfur containing amino acids are suitable for use in the present disclosure.

In certain embodiments, the one or more sulfur containing amino acids can include methionine or methionine-related amino acids. For example, the edible product can include at least about 0.5 g/1,000 kcal, about 0.55 g/1,000 kcal, about 0.60 g/1,000 kcal, about 0.65 g/1,000 kcal, about 0.70 g/1,000 kcal, about 0.71 g/1,000 kcal, about 0.75 g/1,000 kcal, about 0.80 g/1000 kcal, about 0.85 g/1,000 kcal, about 0.90 g/1,000 kcal, or about 1 g/1,000 kcal methionine or methionine-related amino acids. In particular embodiments, the edible product can include at least about 1.3 g/1,000 kcal, about 1.35 g/1,000 kcal, or about 1.37 g/1,000 kcal methionine or methionine-related amino acids. In certain embodiments, the edible product can include from about 0.5 g/1,000 kcal to about 1 g/1,000 kcal or about 0.65 g/1,000 kcal to about 0.75 g/1,000 kcal, or about 0.71 g/1,000 kcal methionine or methionine-related amino acids. In particular embodiments, the edible product can include at least about, or more than about 0.71 g/1,000 kcal methionine or methionine-related amino acids.

In certain embodiments, the one or more sulfur containing amino acids can include cysteine or cysteine-related amino acids, including but not limited to, taurine and/or N-acetyl cysteine. For example, the edible product can include at least about 1 g/1,000 kcal, about 1.25 g/1,000 kcal, about 1.4 g/1,000 kcal, about 1.5 g/1,000 kcal, about 1.65 g/1000 kcal, about 1.75 g/1000 kcal, about 1.9 g/1,000 kcal, about 1.95 g/1,000 kcal, about 1.97 g/1,000 kcal, about 2.0 g/1000 kcal, about 2.10 g/1,000 kcal, about 2.13 g/1,000 kcal, or about 2.2 g/1,000 kcal cysteine or cysteine-related amino acids. In particular embodiments, the edible food product can include at least about 1.25 g/1,000 kcal, about 1.30 g/1,000 kcal, about 1.31 g/1,000 kcal cysteine or cysteine-related amino acids. In certain embodiments, the edible product can include from about 1 g/1,000 kcal to about 2.2 g/1,000 kcal, about 1.5 g/1,000 kcal to about 2.0 g/1,000 kcal, or about 1.97 g/1,000 kcal cysteine or cysteine-related amino acids.

In certain embodiments, the edible product can include less than about 1 g/1,000 kcal, about 1.25 g/1,000 kcal, about 1.4 g/1,000 kcal, about 1.5 g/1,000 kcal, about 1.65 g/1000 kcal, about 1.75 g/1000 kcal, about 1.9 g/1,000 kcal, about 1.95 g/1,000 kcal, about 1.97 g/1,000 kcal, about 2.0 g/1000 kcal, about 2.10 g/1,000 kcal, about 2.13 g/1,000 kcal, or about 2.2 g/1,000 kcal cysteine or cysteine-related amino acids. In particular embodiments, the edible food product can include less than about 1.25 g/1,000 kcal, about 1.30 g/1,000 kcal, about 1.31 g/1,000 kcal cysteine or cysteine-related amino acids. In particular embodiments, the edible pet food product can include less than about 1.97 g/1,000 kcal cysteine or cysteine-related amino acids.

In certain embodiments, the edible product can include at least two sulfur containing amino-acids. In certain embodiments, the edible product can include methionine or a methionine-related amino acid and cysteine or a cysteine-related amino acid. In certain embodiments, an animal's usual diet can include, for example, a pet food composition having a ratio of methionine or methionine-related amino acid and cysteine or cysteine-related amino acid of 1:1 or, for example, up to 1:1.25.

In certain embodiments, the edible product can include at least about 0.5 g/1,000 kcal methionine or methionine-related amino acids and at least about 1.25 g/1,000 kcal cysteine or cysteine-related amino acids. In certain embodiments, the edible product can include at least about 1.37 g/1,000 kcal methionine or methionine-related amino acids and at least about 1.31 g/1,000 kcal cysteine or cysteine-related amino acid. In particular embodiments, the edible product can include about 1.37 g/1,000 kcal methionine or methionine-related amino acids and about 1.31 g/1,000 kcal cysteine or cysteine-related amino acid. In particular embodiments, the edible product can include about 0.55 g/1,000 kcal methionine or methionine-related amino acid and about 2.13 g/1,000 kcal cysteine or cysteine-related amino acid. In particular embodiments, the edible product can include about 0.71 g/1,000 kcal methionine or methionine-related amino acid and about 1.97 g/1,000 kcal cysteine or cysteine-related amino acid.

In certain embodiments, the cysteine or cysteine providing derivative can be present in an amount such that the weight ratio of methionine to available cysteine is from about 1:0.8 to about 1:2.5, from about 1:0.95 to about 1:2.75, or from about 1:0.95 to about 1:2.77. In particular embodiments, the cysteine or cysteine providing derivative can be present in an amount such that the weight ratio of methionine to available cysteine is about 1:0.95, about 1:3.87, or about 1:2.77.

In certain embodiments, the edible product can include an amount of sulfur containing amino acids effective to improve oral health of the animal, e.g., by modulation of the oral microbiota. In some embodiments, modulation of the oral microbiota can include increasing the number, presence or ratio of bacterial species associated with good oral health, particularly species strongly associated with good oral health in a companion animal to which the edible product is administered, compared to the expected microbiota in that companion animal, if the edible product was not administered. Further, in certain embodiments, modulation of the oral microbiota can include decreasing the number, presence or ratio of bacterial species associated with poor oral health or with disease, particularly species strongly associated with poor oral health or disease in an animal to which the edible product is administered, compared to the expected microbiota in that animal, if the edible product was not administered. Amounts of the one or more sulfur containing amino acids vary depending on the food product administered.

For example, any not by way of limitation, the edible product can include one or more sulfur containing amino acids including methionine or methionine-related amino acids and cysteine or cysteine-related amino acids. In certain embodiments, the edible product can include at least about 0.5 g/1,000 kcal methionine or methionine-related amino acids and at least about 1 g/1,000 kcal cysteine or cysteine-related amino acids. In particular embodiments, the edible food product can include at least about 1.37 g/1,000 kcal methionine or methionine-related amino acids and at least about 1.31 g/1,000 kcal cysteine or cysteine-related amino acids. In certain embodiments, the edible food product can have a ratio of methionine or methionine-related amino acids and cysteine or cysteine-related amino acids of about 1:0.95.

Such edible products can advantageously improve the oral health of an animal by increasing the number, prevalence and/or ratio of bacteria associated with good oral health as compared to if the edible product was not administered; decreasing the number, prevalence and/or ratio of bacterial associated with bad oral health as compared to if the edible product was not administered; or combinations thereof. In particular embodiments, the edible product can increase the number, prevalence, and/or ratio of bacteria generally associated with good oral health, for example, and not by way of limitation, generally, Bacteroidetes, Proteobacteria, Fusobacteria, Actinobacteria, or combinations thereof. In certain embodiments, the edible product can decrease the number, prevalence, and/or ratio of bacteria generally associated with bad oral health, for example, and not by way of limitation, generally, Firmicutes, Actinobacteria, Synergistetes, WS6, Spirochaetae, Chlorobi, or combinations thereof.

### E. Methods of Use or Treatment

The methods of the disclosed subject matter can include administering or feeding the edible pet food product to the animal to modulate the oral microbiota of the animal. The methods of the disclosed subject matter are particularly well suited for use with companion animals, such as dogs, cats, and other domesticated animals.

In certain aspects, the edible product can be administered to an animal with a clean mouth, e.g., after it has received a scale and polish. Without being bound by the theory, the edible product is thought to encourage the colonization of the clean mouth with more bacteria not associated with periodontal disease compared to a clean mouth to which an edible product is not administered.

In certain aspects, the edible product can be administered daily or more than once daily to the animal. In certain embodiments, the edible product can be administered to the animal daily, twice weekly, weekly or fortnightly. In certain embodiments, the edible product can be administrated to the animal at least 5, 10, 15, 20, 25, 30, 45, 60, 90 or 120 times. In certain embodiments, a supplement (e.g., a topper) can be administered to the animal. In particular embodiments, the edible product can be administered to the animal at least 5 times. In certain aspects, the edible product can be administered to an animal with a clean mouth, e.g., after it has received a scale and polish or that has had its teeth cleaned, or generally having healthy gingiva. Without being bound by the theory, the edible product is thought to encourage the colonization of the clean mouth with more bacteria not associated with periodontal disease compared to a clean mouth to which an edible product is not administered. Further, in certain aspects, the method can also include the step of cleaning the animal's teeth or mouth.

The present disclosure provides kits that are useful in the modulation of the oral microbiota of an animal, e.g., to improve oral health of the animal. The kits can be used to administer and track administration of diets such as supplements or chews including sulfur containing amino acids to an animal. In certain aspects, the kits can be used to collect a sample in which one or more bacteria associated with an oral disease or disorder (e.g., periodontal disease) or good oral health are detected. A kit for modulating the oral microbiota of an animal can generally include, amongst other things, sample collection devices for collection of samples, one or more food compositions such as diets, supplements or oral chews for administering to the animal, and instructions with respect to appropriate diet regimens for the animal.

### EXAMPLES

For purpose of understanding and not limitation, the presently disclosed subject matter will be better understood by reference to the following Example, which is provided as exemplary of the disclosed subject matter, and not by way of limitation.

### Example 1: Sulfur Containing Amino Acid Content and Oral Microbiota in Dogs

This example investigates the effect of administration of methionine and other sulfur containing amino acids on oral microbiota in dogs (e.g., Labrador Retrievers). Particularly, the impact of varying methionine (and cysteine) levels on the profile of the canine oral microbiota is disclosed. Methionine is a sulfur containing amino acid indirectly important for maintaining heart health, among other aspects. The long term trial fed three semi-purified diets (Diet Group A, Diet Group B, and Diet Group C). A pelleted semi-purified diet (Ssniff Speziäldiaten Gmbh) was utilized to enable manipulation of methionine and cysteine content while keeping other nutrients constant. All diets were nutritionally complete, iso-caloric and iso-nitrogenous (through altering alanine content), and were fed to maintain an ideal body condition score. Supragingival plaque from a number of the dogs split across the three diet groups were sampled and analyzed as set forth herein.

### Methods

Sampling Strategy and Study Cohort

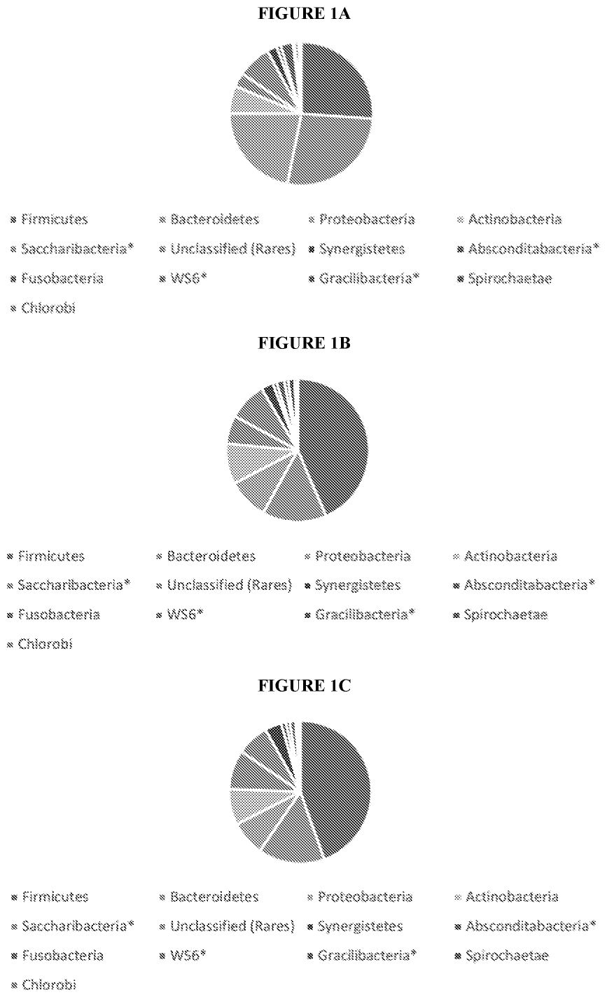

The microbiome of the oral cavity was studied using fourteen (14) adult Labrador Retrievers. Supragingival plaque was sampled on three occasions at least a week apart. The dog groups were split across three semi-purified diets which varied in methionine and cysteine concentrations: five (5) dogs were fed Diet Group A (DG-A; 1.37 g/1,000 kcal methionine, 1.31 g/1,000 kcal cysteine), five (5) dogs were fed Diet Group B (DG-B; 0.55 g/1,000 kcal methionine, 2.13 g/1,000 kcal cysteine) and four (4) dogs were fed Diet Group C (DG-C; 0.71 g/1,000 kcal methionine, 1.97 g/1,000 kcal cysteine). A contingency day was scheduled to allow for the instance of an unsuccessful collection. Plaque samples were collected from both sides of the mouth (left and right) and treated separately. Supragingival plaque collection was performed using sterile microbiological loops from the buccal side, i.e., side closest to the cheek. The sampling was initiated with maxillary third and fourth premolars (107 and 108) and mandible fourth premolar (408) from the first sampling side, then repeated with the other side (207, 208, 308). For the animals more comfortable with mouth handling procedures, additional sample collections were attempted from the maxillary third incisors (103 or 203) and canines (104 and 404 or 204 and 304) (see FIGS. 1A-1C). See, e.g., American Veterinary Dental College (AVDC) web site for teeth nomenclature and numbering (https://www.avdc.org/Nomenclature/Nomen-Dental Anatomy.html).

DNA Extraction & Amplification of 16S rDNA

DNA was extracted from all the samples using a Masterpure Gram Positive DNA Purification Kit (Epicentre, U.S.), according to the manufacturer's instructions. All samples were centrifuged at 5000×g for 10 minutes and the pellet resuspended in 150 μl TE buffer (10 mM Tris-Cl and 0.5 mM EDTA pH9.0). Pooled plaque samples were centrifuged as described above, resuspended in 75 μl TE buffer, and combined to a total volume of 150 μl consistent with the other samples. Primers used are shown in Table 1.

TABLE 1
Primers

| Name | Sequence |
|---|---|
| 319F_1 | CAAGCAGAAGACGGCATACGAGATGTGACTGGAGTTCAG |
| | ACGTGTGCTCTTCCGATCTCCTAAACTACGGACTCCTAC |
| | GGGAGGCAGCAG [SEQ ID NO. 1] |
| 319F_3 | CAAGCAGAAGACGGCATACGAGATGTGACTGGAGTTCAG |
| | ACGTGTGCTCTTCCGATCTCCATCACATAGGACTCCTAC |
| | GGGAGGCAGCAG [SEQ ID NO. 2] |
| 319F_5 | CAAGCAGAAGACGGCATACGAGATGTGACTGGAGTTCAG |
| | ACGTGTGCTCTTCCGATCTACTTTAAGGGTGTACTCCTA |
| | CGGGAGGCAGCAG [SEQ ID NO. 3] |
| 319F_6 | CAAGCAGAAGACGGCATACGAGATGTGACTGGAGTTCAG |
| | ACGTGTGCTCTTCCGATCTGAGCAACATCCTTACTCCTA |
| | CGGGAGGCAGCAG [SEQ ID NO. 4] |
| 319F_7 | CAAGCAGAAGACGGCATACGAGATGTGACTGGAGTTCAG |
| | ACGTGTGCTCTTCCGATCTTGTTGCGTTTCTGTACTCCT |
| | ACGGGAGGCAGCAG [SEQ ID NO. 5] |
| 319F_9 | CAAGCAGAAGACGGCATACGAGATGTGACTGGAGTTCAG |
| | ACGTGTGCTCTTCCGATCTAGGTACGCAATTGTACTCCT |
| | ACGGGAGGCAGCAG [SEQ ID NO. 6] |
| 319F_11 | CAAGCAGAAGACGGCATACGAGATGTGACTGGAGTTCAG |
| | ACGTGTGCTCTTCCGATCTTGTCTCGCAAGCCGAACTCC |
| | TACGGGAGGCAGCAG [SEQ ID NO. 7] |
| 319F_13 | CAAGCAGAAGACGGCATACGAGATGTGACTGGAGTTCAG |
| | ACGTGTGCTCTTCCGATCTGTTACGTGGTTGATGAACTC |
| | CTACGGGAGGCAGCAG [SEQ ID NO. 8] |
| 319F_15 | CAAGCAGAAGACGGCATACGAGATGTGACTGGAGTTCAG |
| | ACGTGTGCTCTTCCGATCTCGTAAGATGCCTATGAACTC |
| | CTACGGGAGGCAGCAG [SEQ ID NO. 9] |
| 319F_16 | CAAGCAGAAGACGGCATACGAGATGTGACTGGAGTTCAG |
| | ACGTGTGCTCTTCCGATCTTACCGGCTTGCATGCGAACT |
| | CCTACGGGAGGCAGCAG [SEQ ID NO. 10] |
| 319F_17 | CAAGCAGAAGACGGCATACGAGATGTGACTGGAGTTCAG |
| | ACGTGTGCTCTTCCGATCTATCTAGTGGCAATGCGAACT |
| | CCTACGGGAGGCAGCAG [SEQ ID NO. 11] |
| 319F_19 | CAAGCAGAAGACGGCATACGAGATGTGACTGGAGTTCAG |
| | ACGTGTGCTCTTCCGATCTCACCTTACCTTAGAGTGGAC |
| | TCCTACGGGAGGCAGCAG [SEQ ID NO. 12] |
| 319F_21 | CAAGCAGAAGACGGCATACGAGATGTGACTGGAGTTCAG |
| | ACGTGTGCTCTTCCGATCTGCACTTCATTTCGAGTGGAC |
| | TCCTACGGGAGGCAGCAG [SEQ ID NO. 13] |
| 319F_23 | CAAGCAGAAGACGGCATACGAGATGTGACTGGAGTTCAG |
| | ACGTGTGCTCTTCCGATCTCGCGGTTACTAACCTGGAGA |
| | CTCCTACGGGAGGCAGCAG [SEQ ID NO. 14] |
| 806R_1 | AATGATACGGCGACCACCGAGATCTACACTCTTTCCCTA |
| | CACGACGCTCTTCCGATCTCCTAAACTACGGGGACTACH |
| | VGGGTWTCTAAT [SEQ ID NO. 15] |
| 806R_3 | AATGATACGGCGACCACCGAGATCTACACTCTTTCCCTA |
| | CACGACGCTCTTCCGATCTCCATCACATAGGGGACTACH |
| | VGGGTWTCTAAT [SEQ ID NO. 16] |
| 806R_5 | AATGATACGGCGACCACCGAGATCTACACTCTTTCCCTA |
| | CACGACGCTCTTCCGATCTACTTTAAGGGTGAGGACTAC |
| | HVGGGTWTCTAAT [SEQ ID NO. 17] |
| 806R_6 | AATGATACGGCGACCACCGAGATCTACACTCTTTCCCTA |
| | CACGACGCTCTTCCGATCTGAGCAACATCCTAGGACTAC |
| | HVGGGTWTCTAAT [SEQ ID NO. 18] |
| 806R_7 | AATGATACGGCGACCACCGAGATCTACACTCTTTCCCTA |
| | CACGACGCTCTTCCGATCTTGTTGCGTTTCTTCGGACTA |
| | CHVGGGTWTCTAAT [SEQ ID NO. 19] |
| 806R_9 | AATGATACGGCGACCACCGAGATCTACACTCTTTCCCTA |
| | CACGACGCTCTTCCGATCTAGGTACGCAATTTCGGACTA |
| | CHVGGGTWTCTAAT [SEQ ID NO. 20] |
| 806R_11 | AATGATACGGCGACCACCGAGATCTACACTCTTTCCCTA |
| | CACGACGCTCTTCCGATCTTGTCTCGCAAGCCTAGGACT |
| | ACHVGGGTWTCTAAT [SEQ ID NO. 21] |
| 806R_13 | AATGATACGGCGACCACCGAGATCTACACTCTTTCCCTA |
| | CACGACGCTCTTCCGATCTGTTACGTGGTTGGATAGGAC |
| | TACHVGGGTWTCTAAT [SEQ ID NO. 22] |
| 806R_15 | AATGATACGGCGACCACCGAGATCTACACTCTTTCCCTA |
| | CACGACGCTCTTCCGATCTCGTAAGATGCCTGATAGGAC |
| | TACHVGGGTWTCTAAT [SEQ ID NO. 23] |
| 806R_17 | AATGATACGGCGACCACCGAGATCTACACTCTTTCCCTA |
| | CACGACGCTCTTCCGATCTATCTAGTGGCAAACTCAGGA |
| | CTACHVGGGTWTCTAAT [SEQ ID NO. 24] |
| 806R_19 | AATGATACGGCGACCACCGAGATCTACACTCTTTCCCTA |
| | CACGACGCTCTTCCGATCTCACCTTACCTTATTCTCTGG |
| | ACTACHVGGGTWTCTAAT [SEQ ID NO. 25] |
| 806R_21 | AATGATACGGCGACCACCGAGATCTACACTCTTTCCCTA |
| | CACGACGCTCTTCCGATCTGCACTTCATTTCTTCTCTGG |
| | ACTACHVGGGTWTCTAAT [SEQ ID NO. 26] |
| 806R_23 | AATGATACGGCGACCACCGAGATCTACACTCTTTCCCTA |
| | CACGACGCTCTTCCGATCTCGCGGTTACTAACACTTCTG |
| | GACTACHVGGGTWTCTAAT [SEQ ID NO. 27] |
| 806R_24 | AATGATACGGCGACCACCGAGATCTACACTCTTTCCCTA |
| | CACGACGCTCTTCCGATCTGAGACTATATGCCACTTCTG |
| | GACTACHVGGGTWTCTAAT [SEQ ID NO. 28] |

The variable V3-V4 regions of the 16S rRNA were amplified from the DNA extractions. The 16S rRNA gene universal bacterial primers 319F and 806R, each modified with a linker sequence, index sequence and heterogenicity spacer as per Fadrosh et al. 2014, were used for PCR amplification (full sequences shown in Table 1). The PCR mixtures (50 μl) contained 25 μl Phusion® High-Fidelity PCR Master Mix with HF Buffer (M0531, New England Biolabs, UK), 5 μl of each primer (1 μM), 10 μl template DNA, 3.5 μl nuclease free water and 1.5 μl DMSO, prepared in a 96-well format. The PCR cycling conditions consisted of an initial denaturation step at 98° C. (30 s), followed by 30 cycles of 98° C. (15 s), 58° C. (15 s) and 72° C. (15 s) and a final elongation at 72° C. (60 s). Successful amplification was confirmed through electrophoresis of the PCR products on 1.5% agarose gels.

Library Preparation

Library preparation and sequencing was carried out. The 16S rDNA amplicons were pre-quantified using the Quant-iT PicoGreen® dsDNA Assay Kit (Invitrogen, UK). The diluted amplicons were then quantified using the Fragment Analyzer (Advanced Analytical Technologies, Inc.), then pooled into groups of 121/122 samples. The library pools were gel-sized prior to sequencing on a MiSeq (Illumina) with v3 chemistry, 2×300 bp run modus.

Sequence Processing and Analysis

A dual-indexing and assembly approach as described by Fadrosh et al. 2014 was used to sequence the V3-V4 region on Illumina's MiSeq platform. Forward and reverse reads were assembled into contiguous sequences spanning the entire V3-V4 regions using the flash assembler. Tags were removed using TagCleaner and sequences were demultilexed in QIIME using split_libraries_fastq.py and a phred score quality cut-off of 30 (−q 29). Chimeric sequences were removed using userarch61 (reference free). Sequences were clustered at >98% identity using Uclust (Caporaso et al., 2010) and most abundant sequences were chosen as cluster representatives.

Statistical Analysis

Operational taxonomic units (OTUs) were classified in a single group of “rare” taxa if either they were present in each diet group at an average proportion below 0.05% or were present in less than two samples. The 0.05% cut-off was selected based on statistical analysis of data from mock communities. Samples with a total count of less than 1,000 were excluded from analysis. OTUs were then analyzed using logistic regression analyses (generalized linear mixed model with a binomial distribution and log it link) for proportions, using the count of an OTU out of the total number of sequences in a sample, with diet group and their interaction included as fixed effects and animal and rep as the random effects. As the data contained many zero counts, permutation tests (1,000 permutations) were used to allow for deviations from the logistic regression analysis assumptions. The permutation test p-values were then adjusted according to the false discovery method of Benjamini and Hochberg (1995) to allow for the increased likelihood of false positives when analyzing the 185 OTUs.

Shannon diversity index: a linear mixed model was used to analyze the indexes, diet group and their interaction as fixed effects and animal and rep as the random effects.

Statistical analyses were performed in R v3.3.3 using lme4, multcomp, ggplot2 and libraries.

Results

Study Cohort

Supragingival plaque was sampled from a total of 14 Labrador Retrievers on three independent occasions. In total, the trial generated 168 supragingival plaque samples. Following pooling of samples (reducing sample numbers by 84), 84 samples were processed through DNA extraction and PCR amplification.

Sequence Quality

The 16S rRNA V3-V4 region of the 84 samples was analyzed by Illumina MiSeq. After processing through the bioinformatics pipeline, the number of assembled sequence reads was 1,493,234.

Two samples with counts under 1,000 sequence reads were removed prior to statistical analysis. Removal of such samples avoids the possibility for sample bias. The total number of sequence reads remaining for the subsequent analysis was 1,492,429.

Bacterial Composition of Different Locations

The resulting 1,492,429 assembled sequences were assigned to 185 operational taxonomic units (OTUs) following removal of rare sequence reads (see Methods section). The rare group accounted for 7.85% of the total sequence reads.

Taxonomic assignment of each of the 185 OTUs resulted in 168 (90.8%) with ≥98% sequence identity. The remaining 17 OTUs (5.6%) shared between 93.6% and 97.9% identity. Of the 185 OTUs, 84 (45.4%) mapped to sequences of previously identified canine oral taxon (COT) (Dewhirst et al. 2012) and 21 (11.4%) mapped to sequences of previously identified feline oral taxon (FOT) (Dewhirst et al. 2015). The remaining 80 OTUs (43.2%) mapped to other taxa in the Silva database. Of these, 19 (10.3%) were designated species level taxonomy.

The bacterial community composition of the 185 OTUs revealed that 161 sequences belonged to nine (9) phyla: Firmicutes (39.6%), Bacteroidetes (17.9%), Proteobacteria (11.8%), Actinobacteria (8.0%), Synergistetes (3.1%), Fusobacteria (1.6%), Spirochaeatae (0.6%), and Chlorobi (0.1%). The remaining 24 OTUs belonged to four (4) candidate phyla: Saccharibacteria (6.7%), Absconditabacteria (1.0%), WS6 (1.0%) and Gracilibacteria (0.9%).

Associations Between Diet Groups

Across the diet groups, the supragingival plaque samples demonstrated gross differences in phylum level composition (FIGS. 1A-1C and Table 2). For example, the proportion of Firmicutes was lowest, and the proportions of Bacteroidetes and Proteobacteria highest with the Diet Group A (DG-A) samples. Phylum level composition was similar for Diet Group B (DG-B) and Diet Group C (DG-C) samples.

TABLE 2
Phylum Level Compositions

| | Diet Group A | Diet Group B | Diet Group C |
|---|---|---|---|
| | (DG-A) | (DG-B) | (DG-C) |
| Grand Total | 365675 | 487948 | 638806 |
| Firmicutes | 95398 | 211870 | 284235 |
| Bacteroidetes | 99002 | 71381 | 96408 |
| Proteobacteria | 79975 | 45241 | 50558 |
| Actinobacteria | 22988 | 44759 | 51856 |
| Saccharibacteria* | 11591 | 31288 | 56825 |
| Unclassified (Rares) | 27886 | 42319 | 46931 |
| Synergistetes | 8143 | 13330 | 24106 |
| Absconditabacteria* | 3576 | 4353 | 7055 |
| Fusobacteria | 10079 | 8416 | 5465 |
| WS6* | 1602 | 4455 | 8350 |
| Gracilibacteria* | 3100 | 7077 | 3359 |
| Spirochaetae | 1766 | 3164 | 3326 |
| Chlorobi | 569 | 295 | 332 |

Diversity

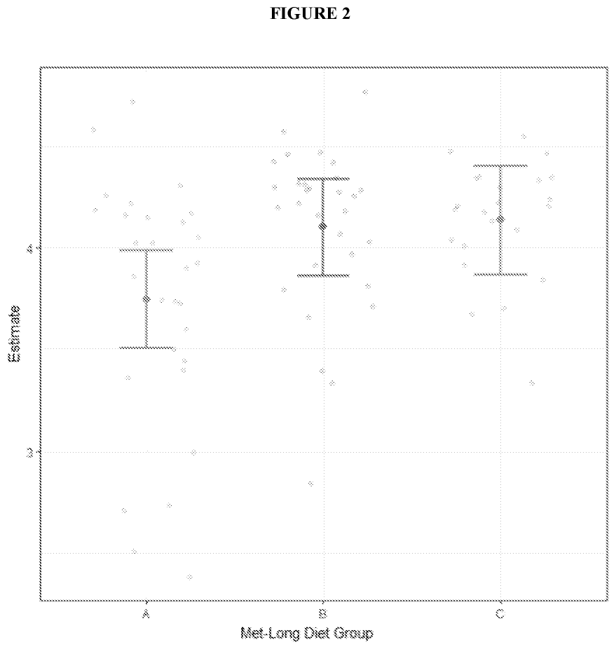

A linear model was used to analyze the Shannon diversity index data and showed some significant differences between the diet groups (FIG. 2). The Shannon diversity index was significantly smaller for Diet Group A (DG-A) samples compared to other diet groups, Diet Group B and Diet Group C (DG-B, DG-C).

### DISCUSSION

The present example advantageously provides for the characterization of the impact of varying levels of a specific amino acid, i.e., methionine, on oral microbiota in dogs. The assignment of taxonomy to the OTUs characterized amongst the study found just over half mapped to previously characterized COT and FOT sequences while the another 33.0% could not be discriminated at the species level and were given novel taxonomic identities. When compared to previous studies profiling canine oral microbiota, these numbers are far lower and higher, respectively (Davis et al. 2013, Wallis et al. 2015). The considerable variation in numbers is suspected to be due to the focus on supragingival plaque, while many of the historic observations have been made using subgingival plaque samples. Subgingival plaque sampling was excluded due to its collection requiring to be performed when the dog is under general anesthesia. A similar rationale can also explain the characterization of few health and/or disease associations to the significant and abundant OTUs identified in the diet comparisons. The findings also highlight the somewhat ‘out of date’ status of current COT and FOT information and the necessity to improve the associated database periodically (Dewhirst et al. 2012, Dewhirst et al. 2015).

Across the supragingival plaque samples, the predominant phyla observed were the Firmicutes, Bacteroidetes, Proteobacteria and Actinobacteria; this is consistent with phyla in subgingival plaque (Davis et al. 2013, Sturgeon et al. 2013, Holcombe et al. 2014, Wallis et al. 2015). The phyla varied proportionally between the diet groups with the Firmicutes being least abundant and the Bacteroidetes and Proteobacteria most abundant in Diet Group A (DG-A). These observations for the majority phyla associated with the semi-purified diet comprising the highest methionine levels, and lowest cysteine levels, are all consistent with the observations made by Davis et al. (2013) and support a healthier plaque microbiome. The higher levels of free methionine can provide indirect support for primary colonisers via dispersal mechanisms of established biofilms (Lam et al. 2009, Kolodkin-Gal et al. 2010).

Further, edible products of the present disclosure can advantageously improve the oral health of an animal by increasing the number, prevalence and/or ratio of bacteria associated with good oral health as compared to if the edible product was not administered; decreasing the number, prevalence and/or ratio of bacterial associated with bad oral health as compared to if the edible product was not administered; or combinations thereof. In particular embodiments, the edible product can increase the number, prevalence, and/or ratio of bacteria generally associated with good oral health, for example, and not by way of limitation, generally, Bacteroidetes, Proteobacteria, Fusobacteria, Actinobacteria, or combinations thereof. In certain embodiments, the edible product can decrease the number, prevalence, and/or ratio of bacteria generally associated with bad oral health, for example, and not by way of limitation, generally, Firmicutes, Actinobacteria, Synergistetes, WS6, Spirochaetae, Chlorobi, or combinations thereof.

Lastly, the semi-purified diet comprising the highest methionine concentration was found to exhibit significantly lower microbial diversity compared to all the other semi-purified diet groups. This confirms for the other two groups that the bacterial diversity remains consistent. The difference in microbial diversity observed with Diet Group A (DG-A) is interesting given the conflicting views on the value of this measure. Human literature supports the healthier microbiota hypothesis discussed here with increased bacterial diversity associated with periodontal disease. In contrast, however, the opposite or no trend have been observed for with canine periodontal disease research studies. The lower diversity could be due to a reduced biofilm biomass comprising fewer bacterial taxa associated with the high concentration of methionine and low concentration of cysteine (Lam et al. 2009, Kolodkin-Gal et al. 2010).

### REFERENCES

Beaglehole, R. H. (2015). “Dentists and sugary drinks: a call to action.” J Am Dent Assoc 146(2): 73-74. Benjamini, Y. and Y. Hochberg (1995). “Controlling the False Discovery Rate: A Practical and Powerful Approach to Multiple Testing.” Journal of the Royal Statistical Society. Series B (Methodological) 57(1): 289300.
Davis, I. J., C. Wallis, O. Deusch, A. Colyer, L. Milella, N. Loman and S. Harris (2013). “A cross-sectional survey of bacterial species in plaque from client owned dogs with healthy gingiva, gingivitis or mild periodontitis.” PLoS One 8(12): e83158.
De Filippis, F., L. Vannini, A. La Storia, L. Laghi, P. Piombino, G. Stellato, D. I. Serrazanetti, G. Gozzi, S. Turroni, I. Ferrocino, C. Lazzi, R. Di Cagno, M. Gobbetti and D. Ercolini (2014). “The same microbiota and a potentially discriminant metabolome in the saliva of omnivore, ovo-lacto-vegetarian and Vegan individuals.” PLoS One 9(11): e112373.
Dewhirst, F. E., E. A. Klein, M. L. Bennett, J. M. Croft, S. J. Harris and Z. V. Marshall-Jones (2015). “The feline oral microbiome: a provisional 16S rRNA gene based taxonomy with full-length reference sequences.” Vet Microbiol 175(2-4): 294-303.
Dewhirst, F. E., E. A. Klein, E. C. Thompson, J. M. Blanton, T. Chen, L. Milella, C. M. Buckley, I. J. Davis, M. L. Bennett and Z. V. Marshall-Jones (2012). “The canine oral microbiome.” PLoS One 7(4): e36067.
Fadrosh, D. W., B. Ma, P. Gajer, N. Sengamalay, S. Ott, R. M. Brotman and J. Ravel (2014). “An improved dual-indexing approach for multiplexed 16S rRNA gene sequencing on the Illumina MiSeq platform.” Microbiome 2(1): 6.
Harrison, M., Thomas, G., Gilham, M., Gray, K., Colyer, A., Allaway, D. (2020) “Short-term determination and long-term evaluation of the dietary methionine requirement in adult dogs” British Journal Nutrition 123(12): 1333-1344.
Holcombe, L. J., N. Patel, A. Colyer, O. Deusch, C. O'Flynn and S. Harris (2014). “Early canine plaque biofilms: characterization of key bacterial interactions involved in initial colonization of enamel.” PLoS One 9(12): e113744.
Kolodkin-Gal, I., D. Romero, S. Cao, J. Clardy, R. Kolter and R. Losick (2010). “D-amino acids trigger biofilm disassembly.” Science 328(5978): 627-629.
Lam, H., D. C. Oh, F. Cava, C. N. Takacs, J. Clardy, M. A. de Pedro and M. K. Waldor (2009). “D-amino acids govern stationary phase cell wall remodeling in bacteria.” Science 325(5947): 1552-1555.
Sheth, C. C., K. Makda, Z. Dilmahomed, R. Gonzalez, A. Luzi, M. Jovani-Sancho Mdel and V. Veses (2016). “Alcohol and tobacco consumption affect the oral carriage of Candida albicans and mutans streptococci.” Lett Appl Microbiol 63(4): 254-259.
Sturgeon, A., J. W. Stull, M. C. Costa and J. S. Weese (2013). “Metagenomic analysis of the canine oral cavity as revealed by high-throughput pyrosequencing of the 16S rRNA gene.” Veterinary Microbiology 162(2): 891898.
Wallis, C., M. Marshall, A. Colyer, C. O'Flynn, O. Deusch and S. Harris (2015). “A longitudinal assessment of changes in bacterial community composition associated with the development of periodontal disease in dogs.” Vet Microbiol 181(3-4): 271-282.
Wallis, C., L. Milella, A. Colyer, C. O'Flynn, S. Harris and L. Holcombe (2018b). Subgingival microbiota of dogs with healthy gingiva or early periodontal disease from different geographical locations.

Although the presently disclosed subject matter and its advantages have been described in detail, it should be understood that various changes, substitutions and alterations can be made herein without departing from the spirit and scope of the disclosed subject matter as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, means, methods, or steps, presently existing or later to be developed that perform substantially the same function or achieve substantially the same result as the corresponding embodiments described herein can be utilized according to the presently disclosed subject matter. Accordingly, the appended claims are intended to include within their scope such processes, machines, manufacture, compositions of matter, means, methods, or steps.

Patents, patent applications, publications, product descriptions and protocols are cited throughout this application the disclosures of which are incorporated herein by reference in their entireties for all purposes.

1-38. (canceled)

39. An edible pet food product comprising one or more sulfur containing amino acids, wherein the one or more sulfur containing amino acids comprises at least about 0.5 g/1,000 kcal methionine or methionine-related amino acid and at least about at least about 1.25 g/1,000 kcal cysteine or cysteine-related amino acid.

40. The edible pet food product of claim 39, wherein the product is an animal feed.

41. The edible pet food product of claim 39, wherein the product is a feed supplement or an additive.

42. The edible pet food product of claim 39, wherein the product comprises methionine and cysteine or a cysteine providing derivative such that the available weight ratio of methionine to cysteine is about 1:0.8 to about 1:2.5.

43. The edible pet food product of claim 39, wherein the product is not a chew.

44. The edible pet food product of claim 39, wherein the product is nutritionally complete.

45. The edible pet food product of claim 39, wherein the product is a supplement.

46. A method of modulating an oral microbiota of a companion animal, comprising:
administering an edible pet food product comprising one or more sulfur containing amino acids to the animal, wherein the one or more sulfur containing amino acids comprises at least about 0.5 g/1,000 kcal methionine or methionine-related amino acid and at least about at least about 1.25 g/1,000 kcal cysteine or cysteine-related amino acid.

47. The method of claim 46, wherein the edible pet food product is administered daily or more than once daily.

48. The method of claim 46, wherein the edible pet food product is administered at least 5 times.

49. The method of claim 48, wherein the pet food product is administered at least 5, 10, 15, 20, 25, 30, 45, 60, 90 or 120 times.

50. The method of claim 46, wherein modulating the oral microbiota comprises increasing the number of species of or prevalence of bacteria associated with good oral health.

51. The method of claim 46, wherein modulating the oral microbiota comprises decreasing the number of species of or prevalence of bacteria associated with poor oral health.

52. The method of claim 46, wherein modulating the oral microbiota comprises increasing the number of species of or prevalence of bacteria from the phyla Bacteroidetes and/or Proteobacteria.

53. The method of claim 46, wherein modulating the oral microbiota comprises increasing the prevalence of bacteria from the species Lautropia sp. COT-060.

54. The method of claim 46, wherein modulating the oral microbiota comprises decreasing the number of species of or prevalence of bacteria from the phyla Firmicutes.

55. The method of claim 46, wherein modulating the oral microbiota comprises decreasing the prevalence of bacteria from the species Peptostreptococcaceae bacterium COT-021.
